(19) United States
(12) Patent Application Publication
(10) Pub. No.: US 2010/0047680 A1
(43) Pub. Date: Feb. 25, 2010

(54) Portable water-activated power supply

(76) Inventor: Sueng-Nien Kao, Taipei City (TW)

Correspondence Address: FRENKEL & ASSOCIATES, 3975 UNIVERSITY DR., STE. 330, FAIRFAX, VA, 22030, US

(21) Appl. No.: 12/229,057

(22) Filed: Aug. 20, 2008

(51) Int. Cl. H01M 6/32; H01M 4/36

(52) U.S. Cl. 429/118; 429/231.8; 429/224

(57) ABSTRACT

A portable water-activated power supply has an insulating body, at least one carbon rod, a metal, a base and a cover. The insulating body has at least one side slot containing water, a middle slot containing water and communicating with the at least one side slot, at least one anode terminal extending to the at least one side slot and a cathode terminal extending to the middle slot. The at least one carbon rod is correspondingly mounted in the at least one side slot and connected to the at least one anode terminal. The metal is mounted in the middle slot and connected to the cathode terminal. The base is mounted on a bottom surface of the insulating body. The cover is mounted on a top surface of the insulating body and has watering holes respectively corresponding to the slots. The water-activated power supply is recyclable and pollution-free.

### BACKGROUND OF THE INVENTION

1. Field of the Invention

The present invention relates to a power supply, especially to a portable power supply that is water-activated and recyclable.

2. Description of the Related Art

Due to increasing environmental consciousness, people have been pushed to reduce the use of plastic bags and batteries that pollute environment. Biodegradable bags can easily replace plastic bags without making a huge and negative impact in human life. However batteries like rechargeable batteries and Lithium-Ion batteries only extend the life span and are still pollutant to the environment after the life span runs out.

To overcome the shortcomings, the present invention provides a portable water-activated power supply to mitigate or obviate the aforementioned problems.

### SUMMARY OF THE INVENTION

The main objective of the invention is to provide a portable water-activated power supply that is recyclable and pollution-free.

The portable water-activated power supply comprises an insulating body, at least one carbon rod, a metal, a base and a cover.

The insulating body has at least one side slot, a middle slot, at least one anode terminal and a cathode terminal. The at least one side slot is formed through a top surface of the insulating body and contains water. The middle slot is formed through the top surface and a bottom surface of the insulating body and communicates with any of the at least one side slot. The at least one anode terminal is partially exposed outside the insulating body and extends to the at least one side slot. The cathode terminal is mounted through and partially exposed outside the insulating body and extends to the middle slot.

The at least one carbon rod is correspondingly mounted in the at least one side slot and connected to the at least one anode terminal.

The metal is mounted in the middle slot and connected to the cathode terminal.

The base is mounted on the bottom surface of the insulating body.

The cover is mounted on the top surface of the insulating body and has multiple watering holes and multiple top taps. The watering holes are formed through the cover and respectively correspond to the at least one side slot and the middle slot. The top taps are respectively and detachably mounted on the watering holes.

Every material inside the water-activated power supply is able to be recycled such that the water-activated power supply is harmless to the environment.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable water-activated power supply in accordance with the present invention;

FIG. 2 is an exploded perspective view of the portable water-activated power supply in FIG. 1;

FIG. 3 is a partial exploded perspective view of the portable water-activated power supply in FIG. 1;

FIG. 4 is a front view in partial section of the portable water-activated power supply in FIG. 1;

FIG. 5 is a top view in partial section of the portable water-activated power supply in FIG. 1;

FIG. 6 is a partial exploded perspective view of a second embodiment of a portable water-activated power supply in accordance with the present invention;

FIG. 7 is a front view in partial section of the portable water-activated power supply in FIG. 6; and

FIG. 8 is a top view in partial section of the portable water-activated power supply in FIG. 6.

### DETAILED DESCRIPTION OF THE PREFERRED EMBODIMENTS

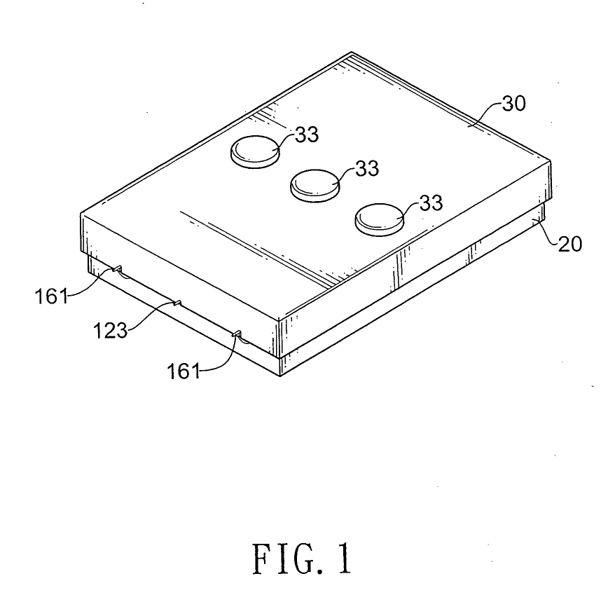

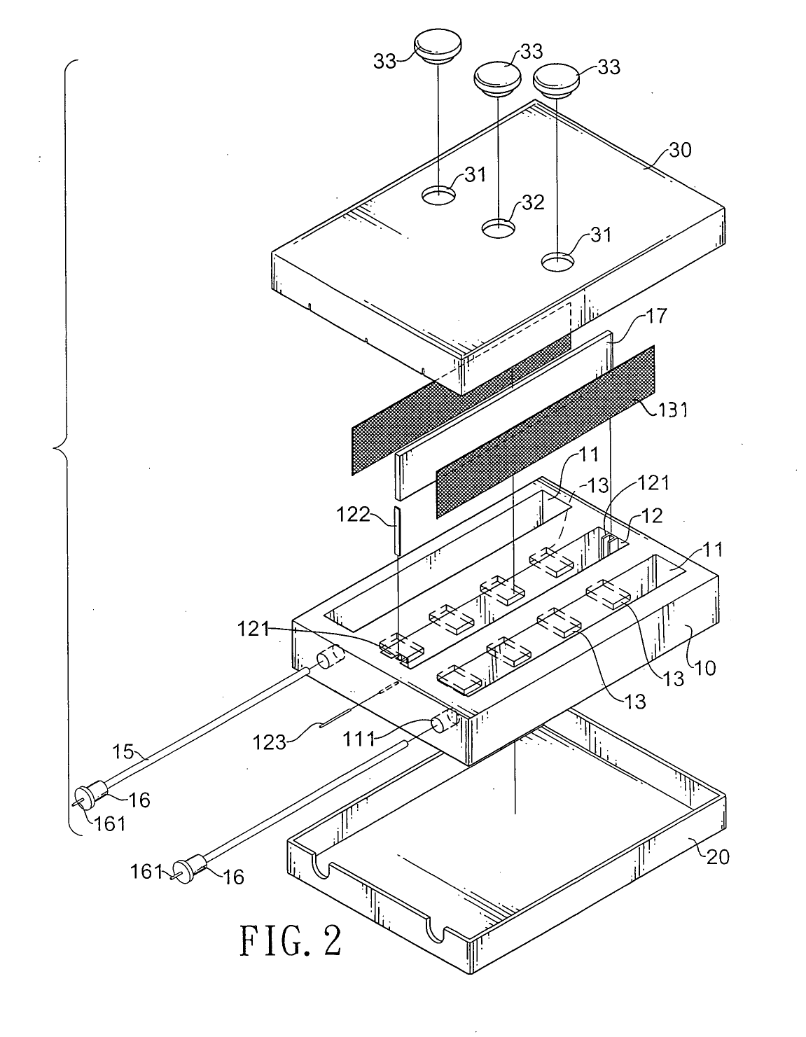

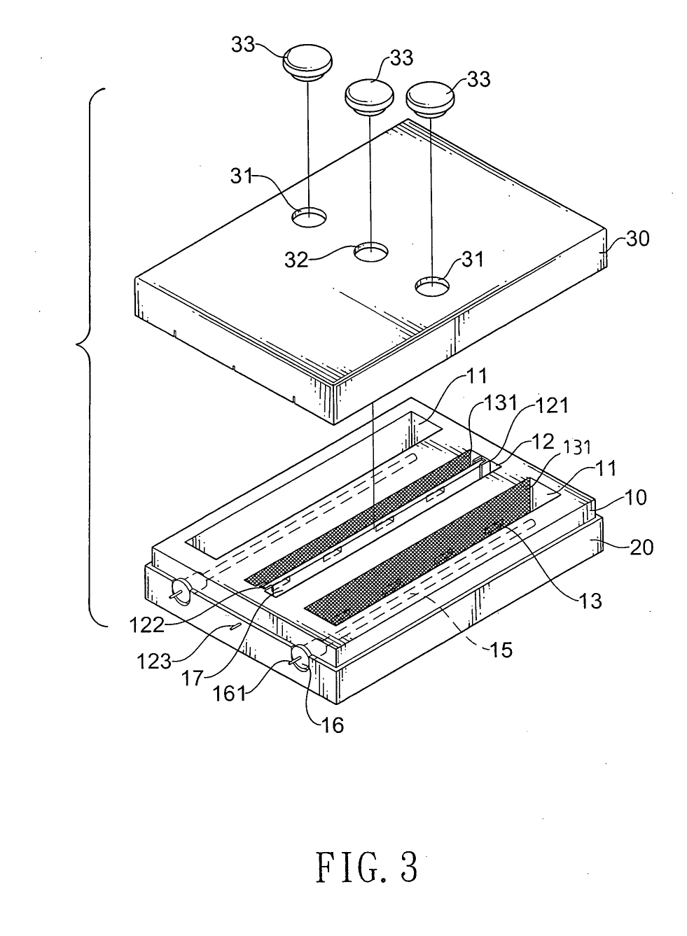

With reference to FIGS. 1 to 3, a portable water-activated power supply in accordance with the present invention comprises an insulating body (10), at least one carbon rod (15), a metal (17), a base (20) and a cover (30).

The insulating body (10) has a top surface, a bottom surface, at least one side slot (11), a middle slot (12), at least one optional mounting hole (111), at least one optional mounting tap (16), at least one anode terminal (161), two optional guide rails (121), an optional metallic sheet (122), a cathode terminal (123), multiple optional channels (13) and at least one filter (131).

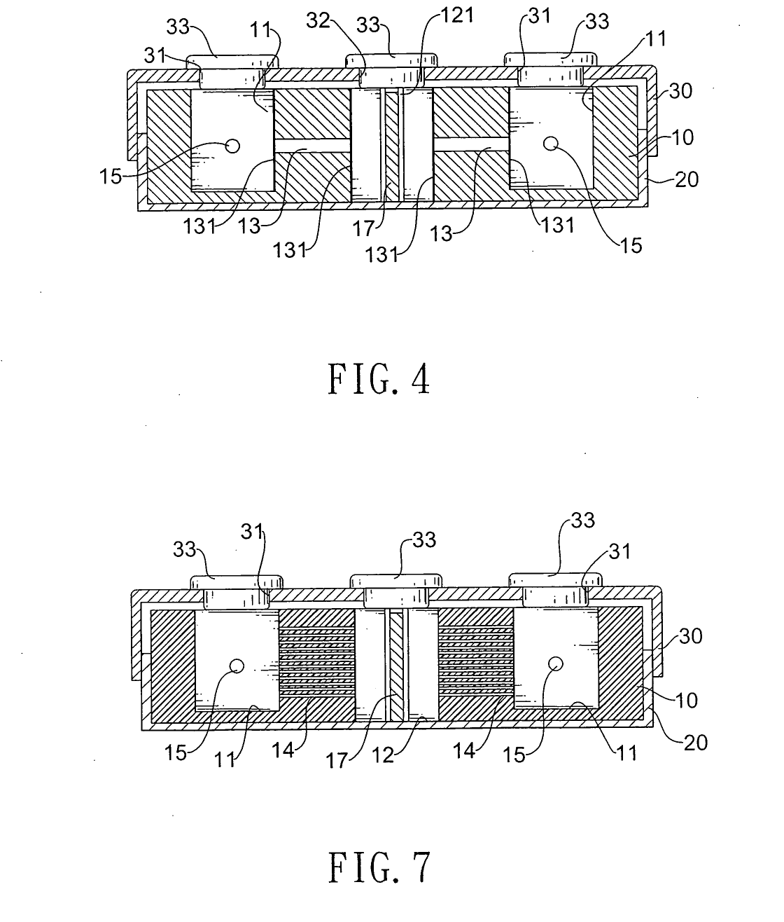

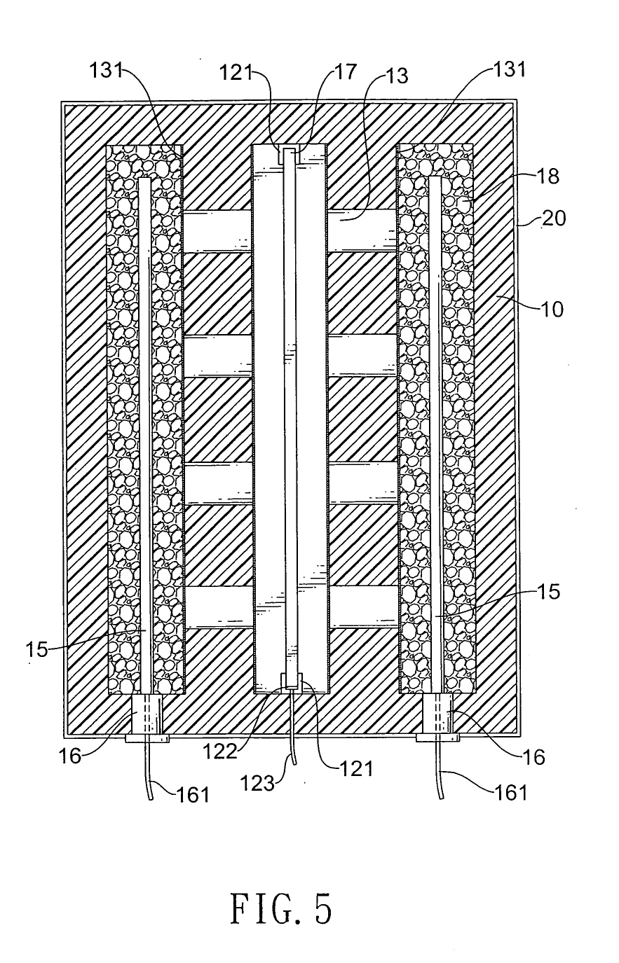

With further reference to FIGS. 4 and 5, the at least one side slot (11) is formed through the top surface of the insulating body (10) and contains water and may further contain active carbon (18). In order to enhance electric conductivity, the active carbon may be soaked in salt solution and then be dried before being putting in the at least one side slot (11), or potassium permanganate may be directly added in the water in the at least one side slot (11). Preferably two side slots (11) are implemented and parallel to each other.

The middle slot (12) is formed through the top surface and the bottom surface of the insulating body (10), communicates with the at least one side slot (11) and may be preferably between two side slots (11).

The at least one mounting hole (111) is formed through a side surface of the insulating body (10) and communicates with the at least one side slot (11).

The at least one mounting tap (16) is correspondingly mounted in the at least one mounting hole (111).

The at least one anode terminal (161) is partially exposed outside the insulating body (10) and extends to the at least one side slot (11) and may be correspondingly mounted through the at least one mounting tap (16).

A number of anode terminals (161), mounting holes (111) and mounting taps (16) correspond to a number of side slots (11), preferably two anode terminals (161), two mounting holes (111) and two mounting taps (16) are implemented. Therefore two mounting holes (111) respectively communicate with the two side slots (11). The two mounting taps (16) are respectively mounting in the mounting holes (111). The anode terminals (161) are respectively mounted through the mounting taps (16).

The slide rails (121) are respectively mounted on two sidewalls of the middle slot (12) and face each other.

The metallic sheet (122) is mounted in one of the slide rails (121).

The cathode terminal (123) is mounted through and partially exposed outside the insulating body (10) and extends to the middle slot (12) and may be connected to the metallic sheet (122).

The channels (13) are formed between the at least one side slot (11) and the middle slot (11) to allow the at least one side slot (11) and the middle slot (11) communicate with each other.

The filters (131) are respectively mounted in the at least one side slot (11) and the middle slot (12) against the channels (13) to prevent particles of metal oxide formed in the middle slot (12) from entering the at least side slot (11).

The at least one carbon rod (15) is correspondingly mounted in the at least one side slot (11) and connected to the at least one anode terminal (161) and may be attached to the at least one mounting tap (16). A number of carbon rods (15) corresponds to a number of anode terminals (161), preferably two carbon rods (15) are implemented and respectively connected to the anode terminals (161).

The metal (17) is mounted in the middle slot (12) and connected to the cathode terminal (123) and may be correspondingly mounted between the two slide rails (121) and may be implemented as a magnesium sheet.

The base (20) is mounted on the bottom surface of the insulating body (10) to cover a bottom opening of the middle slot (12).

The cover (30) is mounted on the top surface of the insulating body (10) and has multiple watering holes (31, 32) and multiple top taps (33). The watering holes (31, 32) are formed through the cover (30) and respectively correspond to the at least one side slot (11) and the middle slot (12) to allow filling the slots (11, 12) with water. The top taps (33) are respectively and detachably mounted on the watering holes (31, 32).

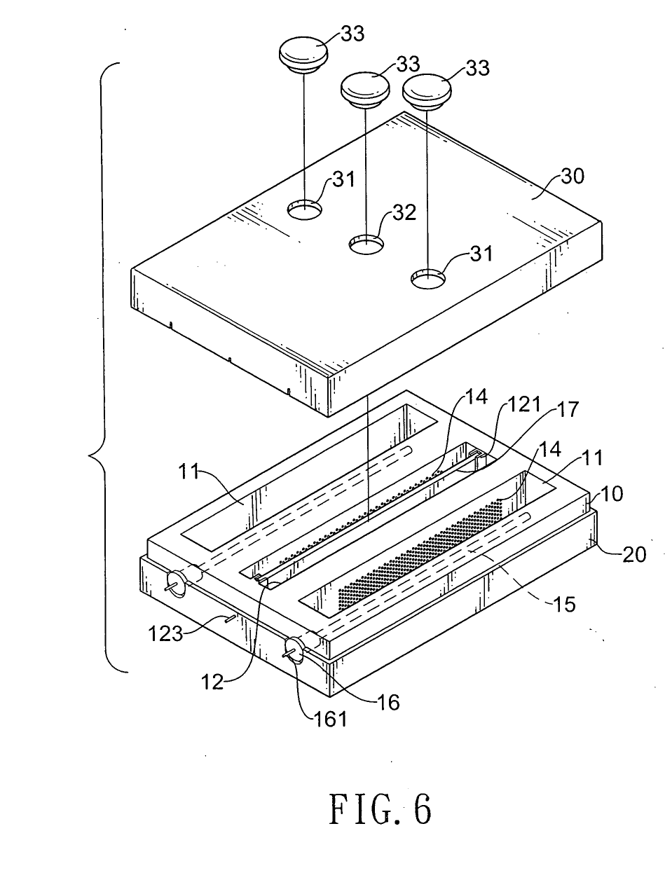

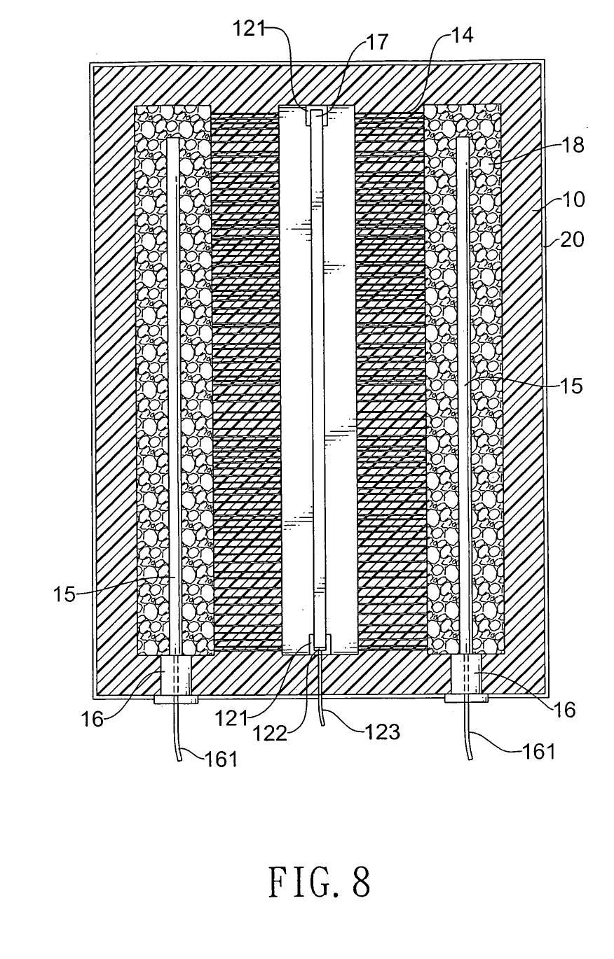

With reference to FIGS. 6 to 8, in another embodiment of the present invention, the insulating body (10) may have multiple filter holes (14) to replace the channels (13) and the filter (131). The filter holes (14) are formed between the middle slot (12) and any one of the at least one side slot (11) to link the middle slot (12) and the at least one side slot (11). Each filter hole (14) is smaller than a particle of active carbon (18).

When water is added and flows in the at least one side slot (11) and the middle slot (12), electric current is produced by chemical reaction of the carbon rod (15), the metal (17) and water. And then the electric current is conducted to the at least one anode terminal (161) and cathode terminal (123). The metal (17) will produce particles of metal oxide in the middle slot (12) while supplying power. Since the middle slot (11) is formed through the bottom surface of the insulating body (10), the particles of metal oxide will precipitate on the base (20). Therefore a user can clean the metal oxide by temporarily detaching the base (20) from the insulating body (10).

Multiple water-activated power supplies may be further assembled together in various ways to be a high-voltage DC battery module.

In conclusion, the water-activated power supply of the present invention is made from materials like carbon, magnesium, and is activated by water and recycled by repeatedly adding water, cleaning metal oxide or replacing the oxidized metal (17). Since every material inside the water-activated power supply is able to be recycled such that the water-activated power supply is harmless to the environment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A portable water-activated power supply comprising:
an insulating body having
a top surface;
a bottom surface;
at least one side slot being formed through the top surface of the insulating body and containing water;
a middle slot being formed through the top surface and the bottom surface of the insulating body and communicating with any one of the at least one side slot;
at least one anode terminal being partially exposed outside the insulating body and extending to the at least one side slot; and
a cathode terminal being mounted through and partially exposed outside the insulating body and extending to the middle slot;
at least one carbon rod being correspondingly mounted in the at least one side slot and connected to the at least one anode terminal;
a metal being mounted in the middle slot and connected to the cathode terminal; and
a base being mounted on the bottom surface of the insulating body; and
a cover being mounted on the top surface of the insulating body and having
multiple watering holes being formed through the cover and respectively corresponding to the middle slot and the at least one side slot; and
multiple top taps being respectively and detachably mounted on the watering holes.

2. The portable water-activated power supply as claimed in claim 1, wherein:
two side slots are implemented and the middle slot is formed between the two side slots;
the insulating body further has
two mounting holes being formed through a side surface of the insulating body and respectively communicating with the side slots; and
two mounting taps being respectively mounted in the mounting holes;
two anode terminals are implemented and respectively mounted through the mounting taps; and
two carbon rods are implemented and respectively attached to the mounting taps and connected to the anode terminals.

3. The portable water-activated power supply as claimed in claim 1, wherein:
the insulating body further has
two slide rails being respectively mounted on two sidewalls of the middle slot and facing each other; and
a metallic sheet being mounted in one of the slide rails and connecting to the cathode terminal; and
the metal is correspondingly mounted between the slide rails.

4. The portable water-activated power supply as claimed in claim 2, wherein:
the insulating body further has
two slide rails being respectively mounted on two sidewalls of the middle slot and facing each other; and
a metallic sheet being mounted in one of the slide rails and connecting to the cathode terminal; and
the metal is correspondingly mounted between the slide rails.

5. The portable water-activated power supply as claimed in claim 3, wherein the insulating body further has
multiple channels being formed between the middle slot and any one of the at least one side slot; and
multiple filters being respectively mounted in the at least one side slot and the middle slot against the channels.

6. The portable water-activated power supply as claimed in claim 4, wherein the insulating body further has
multiple channels being formed between each side slot and the middle slot; and
multiple filters being respectively mounted in the side slots and the middle slot against the channels.

7. The portable water-activated power supply as claimed in claim 3, wherein
the insulating body further has multiple filter holes; and
the filter holes are formed between the middle slot and any one of the at least one side slot.

8. The portable water-activated power supply as claimed in claim 4, wherein
the insulating body further has multiple filter holes; and
the filter holes are formed between the middle slot and each side slot.

9. The portable water-activated power supply as claimed in claim 3, wherein the at least one side slot further contains active carbon.

10. The portable water-activated power supply as claimed in claim 4, wherein each side slot further contains active carbon.

11. The portable water-activated power supply as claimed in claim 9, wherein the active carbon may be soaked in salt solution and then be dried before being putting in the at least one side slot.

12. The portable water-activated power supply as claimed in claim 10, wherein the active carbon may be soaked in salt solution and then be dried before being putting in each side slot.

13. The portable water-activated power supply as claimed in claim 9, wherein potassium permanganate are added in the water in the at least one side slot and the middle slot.

14. The portable water-activated power supply as claimed in claim 10, wherein potassium permanganate are added in the water in the side slots and the middle slot.

15. The portable water-activated power supply as claimed in claim 1, wherein the metal is implemented as a magnesium sheet.
